(19) United States
(12) Patent Application Publication
(10) Pub. No.: US 2018/0287549 A1
(43) Pub. Date: Oct. 4, 2018

(54) SYSTEMS AND APPARATUSES FOR PORTABLE, SOLAR-POWERED POWER GENERATION

(71) Applicant: Solar Mod Systems, Inc., Plano, TX (US)

(72) Inventors: Michael D. Long, Plano, TX (US); Mikel J. Bills, Chino, CA (US)

(21) Appl. No.: 15/941,906

(22) Filed: Mar. 30, 2018

Related U.S. Application Data
(60) Provisional application No. 62/479,867, filed on Mar. 31, 2017.

(51) Int. Cl. H02S 10/40; H02S 20/30; H02S 30/20; F21S 9/04; F21V 21/22; F21V 21/36; F21V 21/15; F21S 9/03

(52) U.S. Cl. CPC H02S 10/40; H02S 20/30; H02S 30/20; F21S 9/04; F21W 2131/10; F21V 21/36; F21V 21/15; F21S 9/035; F21V 21/22

(57) ABSTRACT

Systems and apparatuses are described for portable, solar-powered power generation. The systems and apparatuses include a plurality of solar panels affixed to a shipment container or box similar thereto. The solar panels may be stored within recesses along the sides of the shipment container and protected by protruding frames extending along the outer perimeters of the shipment container sides. The solar panels may be maneuvered via manual or power-aided systems for positioning the solar panels for receiving sunlight to facilitate the solar-powered power generation. The solar-generated power is controlled by an electrical control system for regulating and monitoring the generated power. A telescopic pole including an electrical load (e.g., a plurality of lights) may be raised upward from within the shipment container, and the generated solar power may be directed to the lights for providing illuminance to a surrounding area. Other loads may be powered by the system, as desired.

### CROSS REFERENCE TO RELATED APPLICATIONS

This application claims priority to and the benefit of U.S. Provisional Patent Application No. 62/479,867, filed on Mar. 31, 2017 and entitled “SYSTEMS AND APPARATUSES FOR PORTABLE, SOLAR-POWERED POWER GENERATION,” the disclosure of which is incorporated by reference in its entirety as if the same were fully set forth herein.

### TECHNICAL FIELD

The present systems and apparatuses relate generally to portable solar-powered power generation, and more particularly to solar-powered components, such as lighting equipment, attached to transportable shipment containers having solar panels attached thereto.

### BACKGROUND

In general, typical solar-powered systems are permanently installed on structures and are not designed to be transported. Additionally, the solar-powered systems that are transportable generally are not capable of producing power on large scales. In some scenarios, traditional gas powered generators may provide electricity on a large scale but rely on fossil fuels which may not always be readily available in various scenarios. Therefore, there is a long-felt but unresolved need for a transportable system that allows solar energy to power electronic equipment, such as large lighting fixtures or refrigeration systems.

### BRIEF SUMMARY OF THE DISCLOSURE

Briefly described, and according to one embodiment, aspects of the present disclosure generally relate to solar-powered power generation systems and devices. In one embodiment, the present technology includes a shipment container (or similar style container) with movable solar panels attached thereto, an energy storage system, and connections to power electrical equipment. In one specific embodiment, the equipment includes a lighting system, such as a telescopic pole with attached lights. In a particular embodiment, a shipment container such as the 5′ Quadcon (referred to herein as “Quadcon”), distributed by Charleston Marine Containers, Inc., located in Charleston, S.C., may be retrofitted to include various system elements such as the solar panels, energy storage system, and telescopic pole with attached lights. In certain embodiments, other shipment containers may be used and retrofitted as necessary to include the various system components described herein. During transportation and storage of the shipment container, the solar panels are positioned into a space (e.g., a recess) adjacent to the outer walls of the shipment container and surrounded by a protruding frame. The protruding frame acts as a protective barrier and allows multiple shipment containers to be connected during storage and/or transportation without compromising the solar panels (only the frames touch).

In certain embodiments, when the system is in use (not in storage or transport) the solar panels may be re-positioned by lifting (either manually or electronically) the solar panels to a desired angle so as to collect sun light. Energy generated by the solar panels may be stored in batteries included in the energy storage system. In one embodiment, a telescopic pole may be elevated (either manually or electronically) from the inside of the shipment container upward through an opening in the top of the shipment container. In various embodiments, lights attached to the telescopic pole may be powered by the energy stored in the batteries or the energy immediately produced by the solar panels.

In one embodiment, a portable power generation container is disclosed, comprising: a transportable rigid housing comprising a base, at least two sidewalls, and a top surface, wherein at least one of the at least two sidewalls includes a recess; and at least one solar panel movably affixed to the transportable rigid housing, wherein the at least one solar panel rests within the recess during transport of the portable power generation container and is configured to mechanically extend at least partially outside of the recess when the power generation container is in use.

In various embodiments, the at least two sidewalls comprises four sidewalls, wherein at least two of the four sidewalls each include a recess. In particular embodiments, the at least one of the at least two sidewalls comprises an outwardly protruding frame along a perimeter of the at least one of the at least two sidewalls. Furthermore, in certain embodiments, the recess is contained in an area entirely within the outwardly protruding frame along the perimeter of the at least one of the at least two sidewalls. According to various aspects of the present disclosure, an outermost surface of the outwardly protruding frame protrudes outwardly at a distance greater than an outermost surface of the at least one solar panel while the at least one solar panel rests within the recess. In some embodiments, the outwardly protruding frame comprises at least two connection points for securely connecting to a second portable power generation container, and the at least two connection points are located at separate corners of the outwardly protruding frame.

In one embodiment, the portable power generation container above is disclosed wherein the at least one solar panel is foldable and/or modular. Moreover, is some embodiments, the transportable rigid housing is a quadcon-style shipment container. In particular embodiments, the portable power generation container further comprises a power generation system affixed within an interior of the transportable rigid housing for receiving energy collected by the at least one solar panel and generating power for use by one or more electrical components. According to various aspects of the present disclosure, the portable power generation container further comprises a raisable pole affixed within the interior of the transportable rigid housing in a retracted position during transport of the portable power generation container, wherein the raisable pole is operable to be raised through the top surface of the transportable rigid housing. In some embodiments, the raisable pole is telescopic. In other embodiments, the raisable pole comprises one or more hinged portions for folding the raisable pole at the hinged portions.

In various embodiments, the portable power generation container is disclosed wherein the top surface of the transportable rigid housing comprises an opening to allow for raising the raisable pole through the opening. In one embodiment, the raisable pole is operable to be raised through the opening via a manual crank apparatus. Furthermore, in particular embodiments, the raisable pole is operable to be raised through the opening via a motor operatively connected to the power generation system. In certain embodiments, the raisable pole comprises a light fixture operable to emit light powered by the at least one solar panel and/or the power generation system.

In various embodiments, a portable power generation system is described herein, comprising: a shipment container box having a base, four sidewalls, and a top surface, wherein at least two of the four sidewalls each include a recess; at least one solar panel hingedly affixed to each recess in the at least two sidewalls, wherein the at least one solar panel rests within the recess during transport of the portable power generation system and is configured to mechanically extend outwardly from the recess when the portable power generation system is in use; a power generation system affixed within an interior of the shipment container box and operatively connected to the at least one solar panel for receiving energy collected by the at least one solar panel and generating power; and an extendible light tower affixed within the interior of the shipment container box in a retracted position during transport of the portable power generation system and configured to mechanically extend out of an opening of the shipment container box when in use, the extendible light tower having a light fixture attached thereto and powered by the power generation system when in use.

In various embodiments, the at least two of the four sidewalls each comprise an outwardly protruding frame along a perimeter of the at least two of the four sidewalls. Furthermore, in particular embodiments, the recess is contained in an area entirely within the outwardly protruding frame along the perimeter of the at least two of the four sidewalls. According to various aspects of the present disclosure, an outermost surface of the outwardly protruding frame protrudes outwardly at a distance greater than an outermost surface of the at least one solar panel while the at least one solar panel rests within the recess. In certain embodiments, the outwardly protruding frame comprises at least two connection points for securely connecting to a second portable power generation system. In a particular embodiment, the at least two connection points are located at separate corners of the outwardly protruding frame.

The portable power generation system described above, wherein the at least one solar panel is foldable and/or modular. In one embodiment, the shipment container box is a quadcon-style shipment container. In various embodiments, the extendible light tower is telescopic. In certain embodiments, the extendible light tower comprises one or more hinged portions for folding the extendible light tower at the hinged portions. According to various aspects of the present disclosure, the opening is located at the top surface of the shipment container box. In particular embodiments, the extendible light tower is operable to be mechanically extended through the opening of the shipment container box via a manual crank apparatus. In some embodiments, the extendible light tower is operable to be mechanically extended through the opening of the shipment container box via a motor operatively connected to the power generation system.

These and other aspects, features, and benefits of the claimed invention(s) will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 is a perspective view of a shipment container with a plurality of solar panels affixed thereto, according to one embodiment of the present disclosure;

FIG. 2 is a perspective view of the shipment container showing a circular opening in the roof of the shipment container, according to one embodiment of the present disclosure;

FIG. 3 is a perspective view of the shipment container showing a double panel opening in the roof of the shipment container, according to one embodiment of the present disclosure;

FIG. 4 shows the shipment container with the plurality of solar panels in a raised configuration, according to one embodiment of the present disclosure;

FIG. 5 shows the shipment container with the plurality of solar panels and a telescopic pole both in raised positions, according to one embodiment of the present disclosure;

FIG. 6 illustrates electrical components and an energy storage system, according to one embodiment of the present disclosure;

FIG. 7 is a block diagram illustrating exemplary electrical components of the system, according to one embodiment of the present disclosure; and

FIG. 8 shows the telescopic pole being raised through the double panel opening in the roof of a shipment container, according to one embodiment of the present disclosure.

### DETAILED DESCRIPTION

Briefly described, and according to one embodiment, aspects of the present disclosure generally relate to solar-powered power generation systems and devices. In one embodiment, the present technology includes a shipment container (or similar style container) with movable solar panels attached thereto, an energy storage system, and connections to power electrical equipment. In one specific embodiment, the equipment includes a lighting system, such as a telescopic pole with attached lights. In a particular embodiment, a shipment container such as the 5′ Quadcon (referred to herein as “Quadcon”), distributed by Charleston Marine Containers, Inc. located in Charleston, S.C., may be retrofitted to include various system elements such as the solar panels, energy storage system, telescopic pole with attached lights, etc. In certain embodiments, other shipment containers may be used and retrofitted as necessary to include the various system components described herein. During transportation and storage of the shipment container, the solar panels are positioned into a space (e.g., a recess) adjacent to the outer walls of the shipment container and surrounded by a protruding frame. The protruding frame acts as a protective barrier and allows multiple shipment containers to be connected during storage and/or transportation without compromising the solar panels (only the frames touch).

In certain embodiments, when the system is in use (not in storage or transport) the solar panels may be re-positioned by lifting (either manually or electronically) the solar panels to a desired angle so as to collect sun light. Energy generated by the solar panels may be stored in batteries included in the energy storage system. In one embodiment, a telescopic pole may be elevated (either manually or electronically) from the inside of the shipment container upward through an opening in the top of the shipment container. In various embodiments, lights attached to the telescopic pole may be powered by the energy stored in the batteries or the energy immediately produced by the solar panels.

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates.

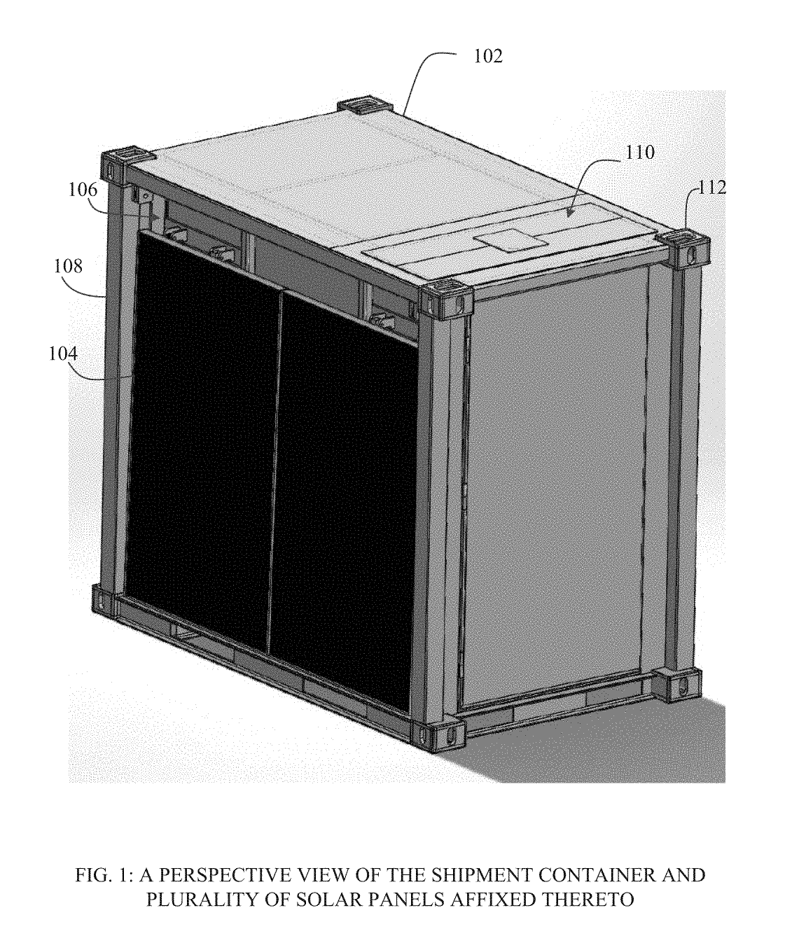

Referring now to the drawings, FIG. 1 illustrates a perspective view of a shipment container 102 with a plurality of solar panels 104 affixed thereto, according to one embodiment of the present disclosure. In particular embodiments, a system including the shipment container 102 and plurality of solar panels 104 is a fully portable system operable to generate energy via the plurality of solar panels 104, and furthermore use the energy to power an electrical load, such as a lighting fixture for providing light in situations where sunlight or other methods of producing energy to provide light are not available. For example, consider a scenario where one is located in a geographical region where electricity is not readily available, however, sunlight is prevalent (e.g., the desert, the tropics, islands etc.). In this scenario, the system described in the present disclosure may be transported to this geographical location (via truck, airplane, boat, helicopter, etc.) and the system may immediately begin to generate energy via the plurality of solar panels 104 for powering electrical loads (e.g., lights, electronics, computers, refrigeration systems, display screens, audio equipment, medical equipment, etc.).

In various embodiments, and as mentioned above, the shipment container 102 may be a Quadcon shipment container. In general, Quadcon shipment containers are about one-fourth of the size of typical shipment containers. In some embodiments, the shipment container 102 may be a retrofitted configuration of another shipment container to allow for various attachments and modifications, such as the plurality of solar panels 104. As shown in the present embodiment, the plurality of solar panels 104 affixed to the shipment container 102 are positioned and mounted flush to a cavity 106 or recess located adjacent to the outer walls of the shipment container 102. In certain embodiments, the cavity 106 is formed by a shipment container frame 108 that protrudes from the outer walls of the shipment container 102. In one embodiment, the protruding shipment container frame 108 protects the plurality of solar panels 104 when they are positioned in the cavity 106 by acting like a bumper. In some embodiments, the plurality of solar panels 104 may align and mount flush with the container frame 108. In certain scenarios, two or more shipment containers 102 may be connected or arranged in a stacked or side-by-side arrangement. In these arrangements, the protruding shipment container frames 108 may be the only portions of the two or more containers 102 touching, thereby ensuring that the plurality of solar panels 104 are protected during either storage, transportation, etc. In other embodiments, the plurality of solar panels 104 may be protected by shutters or shades (e.g., rolling storm shades) that may enclose or otherwise protect the plurality of solar panels 104, or the plurality of solar panels may be maneuverable to be stored within an interior of the shipment container (e.g., a designated and enclosed storage slot, etc.).

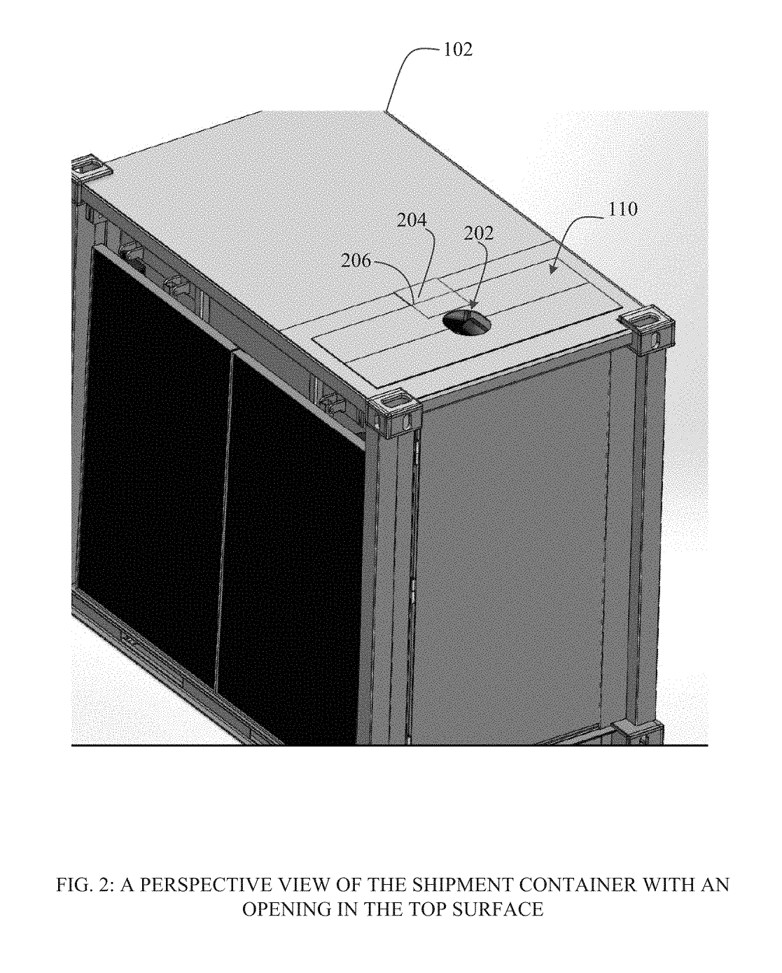

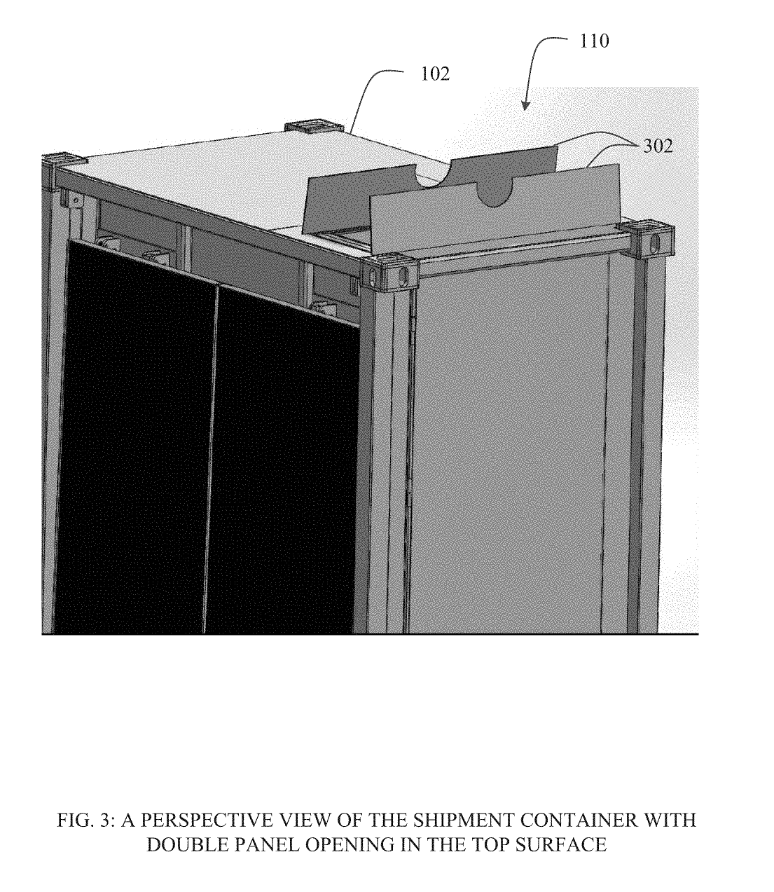

Continuing with FIG. 1, in some embodiments, the shipment container 102 includes at least one roof opening 110. As shown in the present embodiment, the roof opening 110 is in a closed state. As will be described in the discussion of FIGS. 2 and 3, the roof opening 110 may open to allow for components of the system to extend upward through the roof opening 110. In various embodiments, the system includes container connectors 112 at the outer points/corners of the shipment container 102. In one embodiment, the container connectors 112 allow for a shipment container 102 to be securely connected to another shipment container 102 in situations such as during transportation or storage, as briefly discussed above. According to various aspects of the present disclosure, the container connectors 112 may include slots, latches, or other attachment means for attaching to other containers. In particular embodiments, additional hardware (e.g., nuts, bolts, etc.) may be used to secure the shipment containers 102 at the container connectors 112.

Turning now to FIG. 2, the roof opening 110 mentioned in the description of FIG. 1 is shown including a circular opening 202, according to one embodiment. In the present embodiment, the circular opening 202 is revealed by removing the opening cover 204. In various embodiments, the opening cover 204 may be removed by lifting, sliding, folding at a hinge, unlatching, or by another appropriate method or removing the opening cover 204. In particular embodiments, and when the opening cover 204 is removed to reveal the circular opening 202, an opening cover hinge 206 (or bendable/foldable portion) may further allow for the opening cover 204 to bend at the opening cover hinge 206 during opening of the roof opening 110. According to various aspects of the present disclosure, while in a closed state, the roof opening 110 is properly sealed for preventing water or other unwanted debris (e.g., dust, sand, dirt, etc.) from entering the shipment container 102.

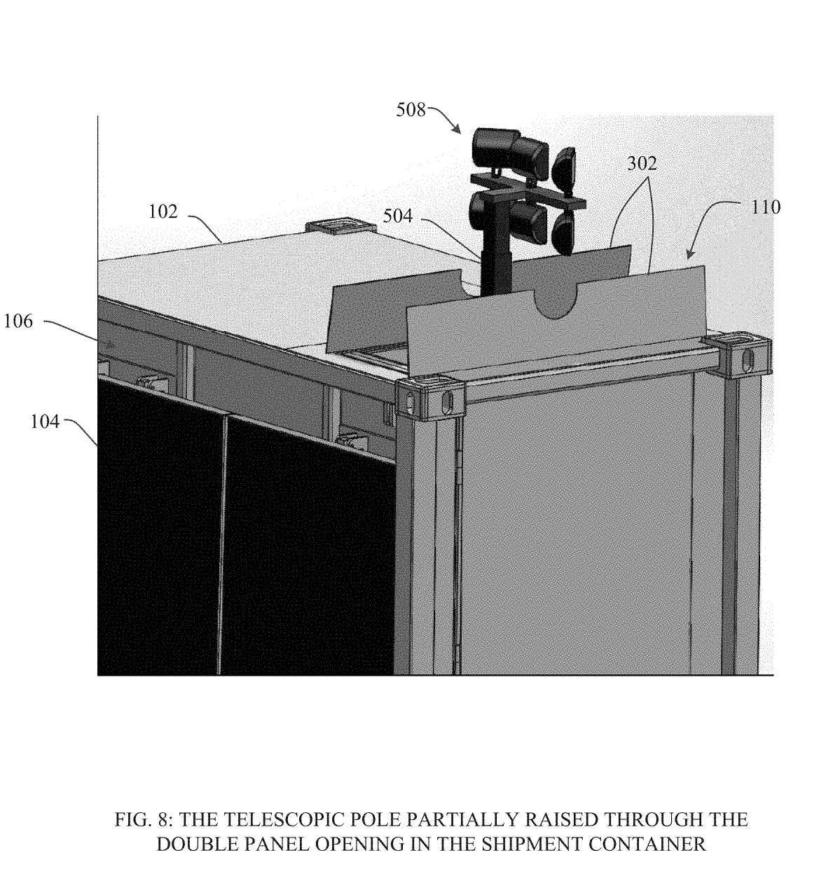

Looking now at FIG. 3, the roof opening 110 is shown including a double panel opening 302, according to one embodiment of the present disclosure. In various embodiments, the double panel opening 302 includes two separate panels that are attached to the roof of the shipment container 102. In certain embodiments, each panel of the double panel opening 302 is attached to the roof of the shipment container 102 by hinges, or another appropriate form of attachment, and furthermore the double panel opening 302 may be slidable, single hinged, totally removable, etc. As will be described below in the discussion of FIG. 8, the double panel opening 302 may allow for objects, such as a telescopic pole, to be raised upwards and outward from within the shipment container 102.

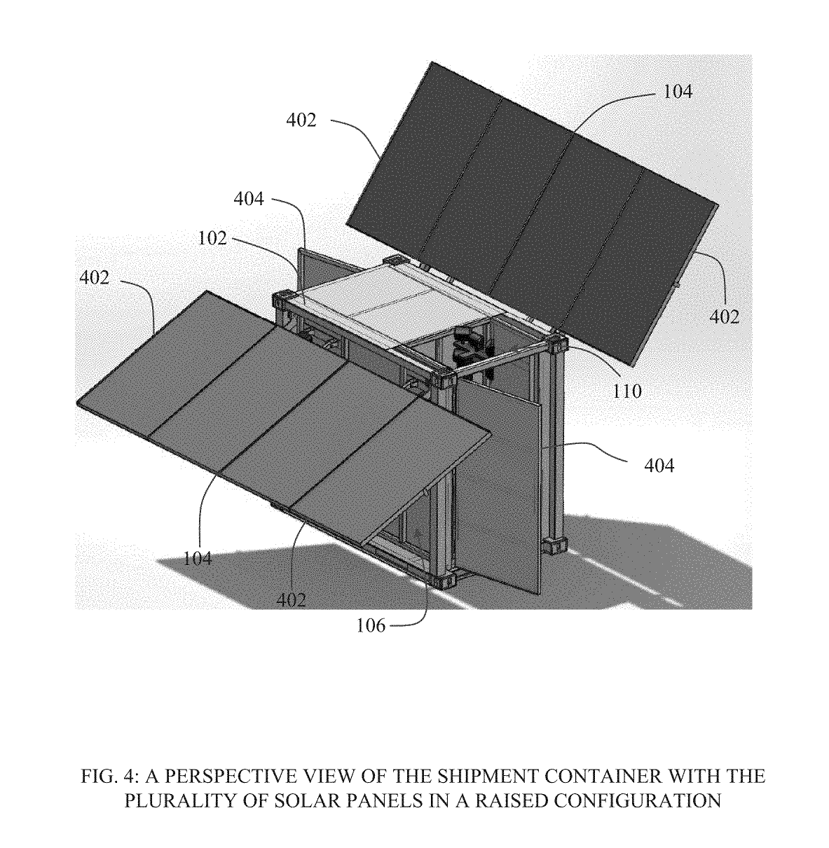

FIG. 4 shows the system in an operational configuration with the plurality of solar panels 104 raised, according to one embodiment of the present disclosure. In various embodiments, the plurality of solar panels 104 may be lifted into titled configurations as desired and appropriate to attract an optimal amount of sunlight. In certain embodiments, in the lifted and tilted configuration, the plurality of solar panels 104 may accept additional solar panels 402. Referring back to the embodiment shown in FIG. 1, only two solar panels are positioned in the cavity 106. Now, looking at FIG. 4, four solar panels are shown as being lifted and tilted out of the cavity 106. In particular embodiments, the plurality of solar panels 104 may be configured to accept the additional solar panels 402. In one embodiment, accepting the additional solar panels 402 may include attaching the additional solar panels 402 via a support beam, or the like, on the underside or another appropriate location of the plurality of solar panels 104. In other embodiments, the additional solar panels 402 may have been unfolded from a previously folded state. In some embodiments, the outer most solar panels (the additional solar panels 402 as shown) may be attached to the inner most solar panels (the plurality of solar panels 104) by a hinge allowing for the outer most solar panels to be folded on-top of or underneath the inner most solar panels. In particular embodiments in which the solar panels are foldable, a locking mechanism may secure the solar panels in the unfolded and folded states. In various embodiments where additional solar panels 402 are included, the additional solar panels 402 may operate in conjunction with the preexisting plurality of solar panels 104. For example, the additional solar panels 402 may allow for the entire collection of solar panels to operate in a daisy chain fashion for generating solar power.

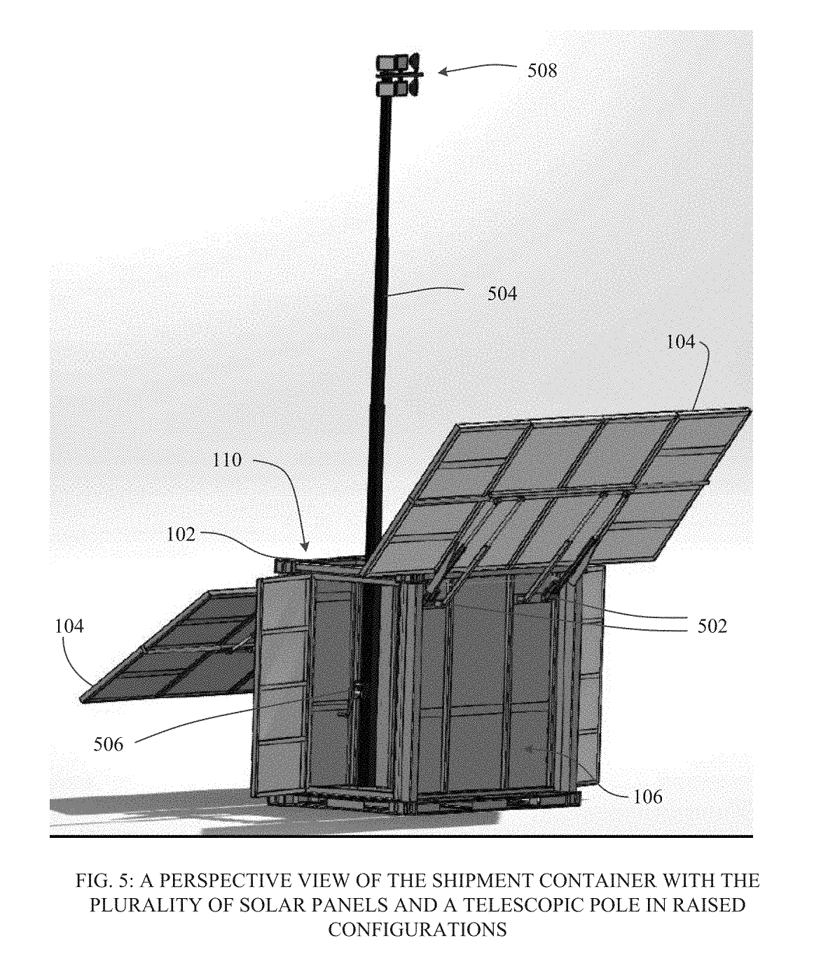

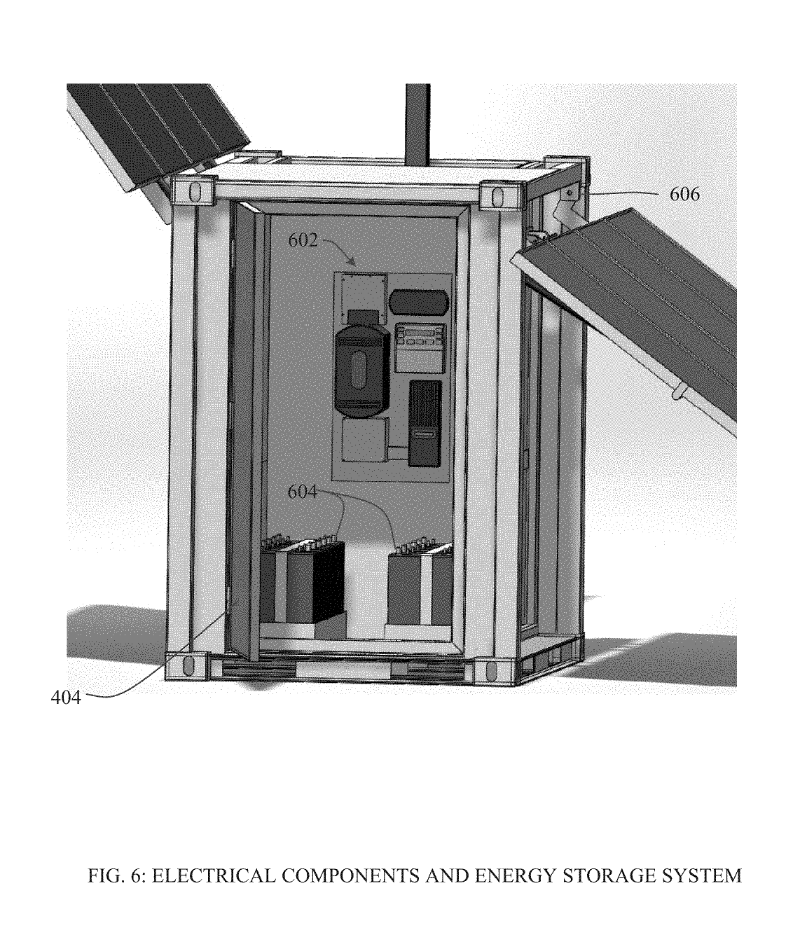

Continuing with FIG. 4, the system includes one or more access doors 404, according to one embodiment. As will be discussed in FIG. 5 and FIG. 6, the one or more access doors 404 allow for access to various components maintained within the shipment container 102. These components may include, but are not limited to, power generating equipment, lighting systems, refrigeration systems, general storage, computers, display screens, servers, medical equipment, etc. Continuing with the present embodiment, the roof opening 110 is shown in a completely open state with the double panel opening 302 unattached from the shipment container 102. In one embodiment, and while the roof opening 110 is in a completely open state, objects maintained within the shipment container 102 may extend up through the roof opening 110 as will be described in greater detail in the discussion of FIG. 5.

Turning now to FIG. 5, a perspective view of the system in an operational configuration is shown, according to one embodiment. As described above in the discussion of FIG. 4, the plurality of solar panels 104 may be lifted and tilted out of the cavity 106. As shown in the present embodiment, the plurality of solar panels 104 may be attached to the shipment container 102 by electric actuator support hinges 502. In other embodiments, the plurality of solar panels 104 may be attached to the shipment container 102 by other forms of hinges, latches, hydraulic gas struts, or any appropriate form of locking mechanism. In one embodiment, the electric actuator support hinges 502 may aid a person in lifting the plurality of solar panels 104 to the desired position. In some embodiments, the system may be configured to use the energy stored via solar power generation to lift the plurality of solar panels 104.

Continuing with FIG. 5, a telescopic pole 504 is shown extending upward through the roof opening 110. In one embodiment, the telescopic pole 504 is raised upward from within the shipment container 102 by a raising tool 506. In various embodiments, the raising tool 506 may be a hand crank, a pulley mechanism, a motorized or electric system, or any appropriate form of tool which can provide the necessary work to raise the telescopic pole 504. In various embodiments, included towards the top of the telescopic pole 504 is a plurality of lights 508. In certain embodiments, the plurality of lights 508 is capable of providing powerful and wide ranging illuminance. In particular embodiments, the plurality of lights 508 may be detachable, tilt-able, rotatable, and substitutable for other mechanisms, attachments, or lighting fixtures. In some embodiments, in addition to or alternatively to including a plurality of lights 508, the telescopic pole 504 may include components such as satellites, antennas, loudspeakers, cranes, etc.

In one embodiment, the telescopic pole 504 may be rotatable at the base of the pole. According to various aspects of the present disclosure, the cross-sectional shape of the telescopic pole 504 may be circular, rectangular, hexagonal, etc. In various embodiments, the telescopic pole 504 may be collapsible in other ways. For example, the pole 504 may include one or more pivot arms. In this example, a pulley or lever mechanism may be operable to lift or “swing” the pivot arms upward and downward. In another example, the pole 504 may include a plurality of individual portions, each portion connected to another by a hinge. In this example, the pole 504 may be raised and lowered by bending and un-bending the individual portions at the hinge locations. In these embodiments, the pole 504 may be stored within the shipment container 102 in a compacted configuration. In particular embodiments, raising or hoisting the pole 504 from within the shipment container 102 may involve swinging the pole upward (e.g., in an arched trajectory), rather than being raised straight upward. In some embodiments, the system may not include a telescopic pole 504 and may alternatively leave the space vacant or include other components.

Proceeding now to FIG. 6, a side view of the system is shown revealing various internal components, according to one embodiment. In various embodiments, one of the one or more access doors 404 may be opened to reveal an electronic control panel 602 and battery arrangement 604. In one embodiment, the electronic control panel 602 may include components such as key pads, power regulator and converters, and other electrical equipment for controlling the system. According to one embodiment, the electronic control panel 602 may be operative to direct the solar generated electricity/power to the battery arrangement 604, the plurality of lights 508, or both simultaneously. According to various aspects of the present disclosure, the electronic control panel 602 may be independent of the electrical load (e.g., the plurality of lights 508), and the lighting system in general, and may not be operable to control the electrical load. In certain embodiments, the electronic control panel 602 may control the raising or lowering of the telescopic pole 504, as well as raising or lowering the plurality of solar panels 104. In a particular embodiment, the battery arrangement 604 may allow for continuous use of the plurality of lights 508 for an extended period of time (e.g., 100 hours or more) without relying on the plurality of solar panels 104 for generating more power. In other embodiments, the battery arrangement 604 may power the plurality of lights 508 for more or less time depending on various system configurations. In one embodiment, the battery arrangement 604 may be powered by a separate power generator (e.g., gasoline generator) in the absence of sun light. In various embodiments, the electronic control panel 602 may monitor the charge of the battery arrangement 604 to ensure that the batteries 604 do not reach discharge levels below a predetermined threshold (e.g., 50%). In a particular embodiment, if the battery arrangement 604 reaches a discharge level below the predetermined threshold, then the plurality of solar panels 104 or a generator may be enabled/activated to generate power for recharging the batteries 604. In particular embodiments, the plurality of solar panels 104 may be continuously charging the battery arrangement 604 regardless of the current discharge levels. In certain embodiments, one or more cooling fans are included in near proximity to the control panel 602 and battery arrangement 604 in order to maintain an appropriate temperature range for the electronic control panel 602 to operate within. In one embodiment, components such as power cords and outlets may be integrated into the system which may allow for the system to power other electronic devices or other systems.

Continuing with FIG. 6, a pivot hinge 606 is shown, according to a particular embodiment. In one embodiment, the pivot hinge 606 is used to attach the plurality of solar panels 104 to the shipment container 102. According to various aspects of the present disclosure, the plurality of solar panels 104 may be attached to each side of the shipment container 102 by one or more pivot hinges 606. In various embodiments, the pivot hinges 606 operate in conjunction with the electric actuator support hinges 502 in order to not only affix the plurality of solar panels 104 to the shipment container 102, but also to guide the plurality of solar panels 104 up and down along a consistent plane when being maneuvered. It should be understood from the discussion herein that other latches, hinges, etc., may be used for attaching or securing the plurality of solar panels 104 to the shipment container 102.

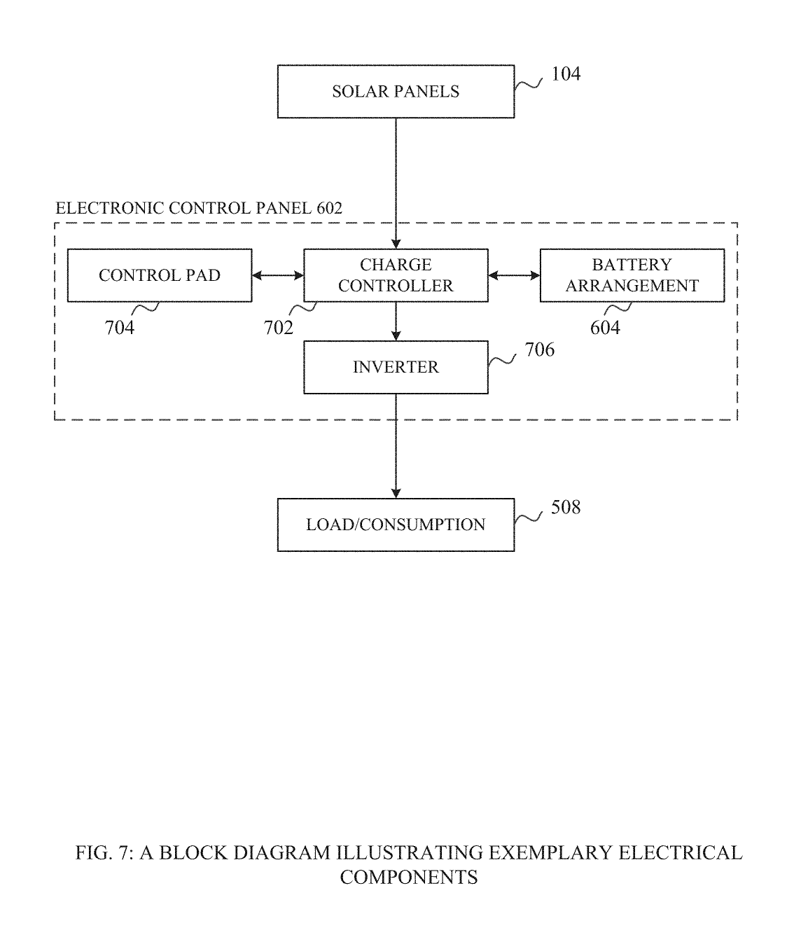

Looking now at FIG. 7, a block diagram is shown illustrating exemplary electrical components of the system, according to one embodiment of the present disclosure. Mentioned briefly above in the discussion of FIG. 6, included within the shipment container 102 is an electronic control panel 602 for controlling, monitoring, and storing solar generated power, according to particular embodiments. The present embodiment illustrates the electronic control panel 602 and its operative connections to both the plurality of solar panels 104 and an electrical load, such as lights or other power consuming devices. In one embodiment, the plurality of solar panels 104 may be connected (via leads or other appropriate power cables) to a charge controller 702 included in the electronic control panel 602. According to various aspects of the present disclosure, the charge controller 702 may be configured to manage the power generated by the plurality of solar panels 104, as well as manage the power stored in the battery arrangement 604. For example, consider a scenario where there is ample sunlight and the battery arrangement 604 is at a 60% charge level. In this example, the power generated by the plurality of solar panels 104 may be received by the charge controller 702 and further directed to the battery arrangement 604 for charging the battery arrangement 604. Continuing with this example, as the battery arrangement 604 nears a complete charge, the charge controller 702 may begin to taper or stop directing the solar generated power to the battery arrangement 604 to prevent overcharging. In some embodiments, the charge controller 702 may detect (via internal meters) that the battery arrangement 604 has reached a predetermined charge level (e.g., 50% charge) and in response begin to direct the solar generated power to the battery arrangement 604. One of ordinary skill in the art will understand that the charge controller 702 described herein may be a pulse width modulation (PWM) controller, a maximum power point tracking (MPPT) charge controller, or any other appropriate type of charge controller.

Continuing with FIG. 7, the electronic control panel 602 includes a control pad 704 for interacting with and configuring the components of the electronic control panel 602, according to various aspects of the present disclosure. In one embodiment, the control pad 704 may include a digital keypad and display for configuring components such as the charge controller 702. For example, a user may interact with the digital keypad and display of the control pad 704 for configuring battery arrangement charge levels that indicate a trigger event for recharging (e.g., 50% charge level). In some embodiments, the control pad 704 may provide a display to a user indicating how much power is being generated by the plurality of solar panels 104, how much power is being consumed by the plurality of lights 508, options for raising or lowering the plurality of solar panels 104 or telescopic pole 504, general information such as time and date, etc.

In a particular embodiment, the charge controller 702 is operatively connected to an inverter 706 (AC/DC) for converting the power generated by the plurality of solar panels 104 (and/or the power stored by the battery arrangement 604) to be consumed by the plurality of lights 508 or other electrical loads such as power strips/outlets for powering computer servers, radio hardware, mobile computing devices, etc.

Proceeding now to FIG. 8, the telescopic pole 504 is shown in a partially raised configuration, according to one embodiment of the present disclosure. In the present embodiment, the plurality of solar panels 104 are shown lowered into the cavity 106 on one side of the shipment container 102. In various embodiments, the telescopic pole 504 may be raised through the roof opening 110 either when the plurality of solar panels 104 is in a raised configuration or in a lowered configuration. According to various aspects of the present disclosure, the telescopic pole 504 may be raised either manually, by means of stored electrical power, or by means of power immediately generated from the plurality of solar panels 104. In one embodiment, the double panel opening 302 may be closed while the telescopic pole 504 is in a raised configuration. Referring back to the discussion of FIG. 2, in some embodiments, a circular opening 202 is present in the roof opening 110. Now, looking at FIG. 8, in a particular embodiment, the double panel opening 302 may be closed while the telescopic pole 504 is in a partially or fully raised configuration and the circular opening may create a seal around the outer surface of the telescopic pole. According to various aspects of the present disclosure, the circular opening 202 may be any shape (square, hexagonal, etc.) in order to accommodate the telescopic pole 504. In certain embodiments, the seal may prevent water or other unwanted debris from entering the shipment container 102.

It should be understood that the embodiments discussed herein were chosen and described in order to explain the principles of the claimed inventions and their practical application so as to enable others skilled in the art to utilize the inventions and various embodiments and with various modifications as are suited to the particular use contemplated. Alternative embodiments will become apparent to those skilled in the art to which the claimed inventions pertain without departing from their spirit and scope. Accordingly, the scope of the claimed inventions is defined by the appended claims rather than the foregoing description and the exemplary embodiments described therein.

What is claimed is:

1. A portable power generation container, comprising:
a transportable rigid housing comprising a base, at least two sidewalls, and a top surface, wherein at least one of the at least two sidewalls includes a recess; and
at least one solar panel movably affixed to the transportable rigid housing, wherein the at least one solar panel rests within the recess during transport of the portable power generation container and is configured to mechanically extend at least partially outside of the recess when the power generation container is in use.

2. The portable power generation container of claim 1, wherein the at least two sidewalls comprises four sidewalls, wherein at least two of the four sidewalls each include a recess.

3. The portable power generation container of claim 1, wherein the at least one of the at least two sidewalls comprises an outwardly protruding frame along a perimeter of the at least one of the at least two sidewalls.

4. The portable power generation container of claim 3, wherein the recess is contained in an area entirely within the outwardly protruding frame along the perimeter of the at least one of the at least two sidewalls.

5. The portable power generation container of claim 3, wherein an outermost surface of the outwardly protruding frame protrudes outwardly at a distance greater than an outermost surface of the at least one solar panel while the at least one solar panel rests within the recess.

6. The portable power generation container of claim 3, wherein the outwardly protruding frame comprises at least two connection points for securely connecting to a second portable power generation container.

7. The portable power generation container of claim 6, wherein the at least two connection points are located at separate corners of the outwardly protruding frame.

8. The portable power generation container of claim 1, wherein the at least one solar panel is foldable and/or modular.

9. The portable power generation container of claim 1, wherein the transportable rigid housing is a quadcon-style shipment container.

10. The portable power generation container of claim 1, further comprising a power generation system affixed within an interior of the transportable rigid housing for receiving energy collected by the at least one solar panel and generating power for use by one or more electrical components.

11. The portable power generation container of claim 10, further comprising a raisable pole affixed within the interior of the transportable rigid housing in a retracted position during transport of the portable power generation container, wherein the raisable pole is operable to be raised through the top surface of the transportable rigid housing.

12. The portable power generation container of claim 11, wherein the raisable pole is telescopic.

13. The portable power generation container of claim 11, wherein the raisable pole comprises one or more hinged portions for folding the raisable pole at the hinged portions.

14. The portable power generation container of claim 11, wherein the top surface of the transportable rigid housing comprises an opening to allow for raising the raisable pole through the opening.

15. The portable power generation container of claim 14, wherein the raisable pole is operable to be raised through the opening via a manual crank apparatus.

16. The portable power generation container of claim 14, wherein the raisable pole is operable to be raised through the opening via a motor operatively connected to the power generation system.

17. The portable power generation container of claim 11, wherein the raisable pole comprises a light fixture operable to emit light powered by the at least one solar panel and/or the power generation system.

18. A portable power generation system, comprising:
a shipment container box having a base, four sidewalls, and a top surface, wherein at least two of the four sidewalls each include a recess;
at least one solar panel hingedly affixed to each recess in the at least two sidewalls, wherein the at least one solar panel rests within the recess during transport of the portable power generation system and is configured to mechanically extend outwardly from the recess when the portable power generation system is in use;
a power generation system affixed within an interior of the shipment container box and operatively connected to the at least one solar panel for receiving energy collected by the at least one solar panel and generating power; and
an extendible light tower affixed within the interior of the shipment container box in a retracted position during transport of the portable power generation system and configured to mechanically extend out of an opening of the shipment container box when in use, the extendible light tower having a light fixture attached thereto and powered by the power generation system when in use.

19. The system of claim 18, wherein the at least two of the four sidewalls each comprise an outwardly protruding frame along a perimeter of the at least two of the four sidewalls.

20. The system of claim 19, wherein the recess is contained in an area entirely within the outwardly protruding frame along the perimeter of the at least two of the four sidewalls.

21. The system of claim 19, wherein an outermost surface of the outwardly protruding frame protrudes outwardly at a distance greater than an outermost surface of the at least one solar panel while the at least one solar panel rests within the recess.

22. The system of claim 19, wherein the outwardly protruding frame comprises at least two connection points for securely connecting to a second portable power generation system.

23. The system of claim 22, wherein the at least two connection points are located at separate corners of the outwardly protruding frame.

24. The system of claim 18, wherein the at least one solar panel is foldable and/or modular.

25. The system of claim 18, wherein the shipment container box is a quadcon-style shipment container.

26. The system of claim 18, wherein the extendible light tower is telescopic.

27. The system of claim 18, wherein the extendible light tower comprises one or more hinged portions for folding the extendible light tower at the hinged portions.

28. The system of claim 18, wherein the opening is located at the top surface of the shipment container box.

29. The system of claim 18, wherein the extendible light tower is operable to be mechanically extended through the opening of the shipment container box via a manual crank apparatus.

30. The system of claim 18, wherein the extendible light tower is operable to be mechanically extended through the opening of the shipment container box via a motor operatively connected to the power generation system.
